(19) United States
(12) Patent Application Publication
(10) Pub. No.: US 2026/0088424 A1
(43) Pub. Date: Mar. 26, 2026

(54) BATTERY MOUNT

(71) Applicant: Project-X18, Inc., Overland Park, KS (US)

(72) Inventors: Brock Templeman, Overland Park, KS (US); Jon Templeman, Overland Park, KS (US)

(21) Appl. No.: 19/072,687

(22) Filed: Mar. 6, 2025

Related U.S. Application Data
(60) Provisional application No. 63/697,803, filed on Sep. 23, 2024.

(51) Int. Cl. H01M 50/249; B60R 16/04; H01M 50/262

(52) U.S. Cl. CPC H01M 50/249; B60R 16/04; H01M 50/262; H01M 2220/20

(57) ABSTRACT

A battery mounting system closely interacts with the hold down features of a specified battery to secure the battery nearly anywhere in a vehicle. The battery mount prevents excessive battery movement—reducing impact shock and vibration to the battery. The battery mount allows multiple batteries to be mounted closer to each other without occupying too much space in a vehicle. The battery mount can be secured with a locking feature, thus preventing theft, and specifies the correct battery group size to use when replacing the battery. The battery mount may also feature brand identity to encourage brand loyalty whenever the battery needs to be replaced. The battery mount may include a branded anti-slip inlay that conceals mounting hardware—creating a clean installation and resulting in an anti-theft battery mounting solution.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/697,803; titled “BATTERY MOUNT”; and filed Sep. 23, 2024. The Provisional Application is hereby incorporated by reference, in its entirety, into the current patent application.

### BACKGROUND OF THE INVENTION

Powered vehicles require batteries of various sizes and shapes. Car manufacturers design their cars using a specific battery size that fulfills the power requirements for starting the engine and running all the electrically operated systems.

Vehicle batteries are dimensionally constrained by several regulatory groups such as BCI (Battery Council International), EN (European Norm), DIN (German Industrial Standard), JIS (Japanese Industrial Standard), etc. For example, BCI Group Sizes are issued to identify the correct battery for automotive applications. Batteries are classified into these numbered group sizes according to their voltage, maximum overall dimensions, terminal arrangement, and special features that may affect battery fit. Given every vehicle's specific electrical needs, BCI Group Sizes ensure that the replacement battery put in the vehicle is equipped to keep it running how the original vehicle manufacturer's engineers intended. BCI Group Sizes cover all types of vehicles, including: passenger cars, trucks, boats, RVs, lawn mowers, ATVs, motorcycles, snow mobiles, jet skis, farm equipment and industrial equipment, etc. Battery manufacturers build their batteries to these specifications to properly market their batteries to the aftermarket and work with vehicle manufactures to create the right battery for each vehicle. Retailers are able to cross reference the BCI, DIN, EN, JIS, etc. Group Sizes when replacing a customer's battery to ensure proper fit and performance.

Automakers design battery trays or battery mounting devices that fit in the space available and mate with the battery they have specified for each vehicle. The vehicle owner may choose to add an additional battery in a remote location to power specific systems such as a car stereo system, winch, additional lighting, etc. The vehicle usually does not have an additional battery mounting device; therefore, an aftermarket battery mount would be needed. Although cars have OE battery trays for mounting the specified battery, other vehicles such as boats, over the road trucks, RVs, motorcycles, etc. usually do not. Universal battery trays or battery boxes can be used to mount these batteries, but they are usually larger than the actual battery footprint, and they do not closely interact with the battery—allowing it to move around and subjecting the battery to damaging impact shock and vibrations.

Batteries can be mounted in unsecured areas such as the front tongue area of a travel-trailer or in unsecured areas in a boat. Because batteries are relatively expensive, batteries mounted in these unsecured areas with universal battery mounts are subject to theft—resulting in a significant loss of time and money to the owner while rendering the vehicle inoperable. Additionally, these types of vehicles often require multiple batteries mounted in a tight space. Because universal battery mounts are larger than the actual battery footprint, batteries using these universal battery trays or boxes usually have the mounting holes located outside of the battery footprint, requiring even more space for installation. As a result, batteries cannot be mounted closely to each other, requiring more overall space to mount them.

Once batteries eventually fail and need to be replaced, universal battery trays and boxes promote no battery brand loyalty or replacement size specification which may result in an improper replacement battery being chosen that can result in poor vehicle performance.

### SUMMARY OF THE INVENTION

Embodiments of the invention provide a battery mounting system that addresses at least some of the above-described problems and that:
Closely interacts with the hold down features of a specified battery.
Prevents excessive movement—reducing impact shock and vibration to the battery.
Allows multiple batteries to be mounted closer to each other.
Can be secured with a locking feature—preventing theft.
Specifies the correct battery group to use when replacing the battery.
Features brand identity to encourage brand loyalty whenever the battery needs to be replaced (for the life of the vehicle).
Employs an anti-slip inlay and hold-down clamp.
Conceals the battery mounting system installation under the anti-slip inlay on which the battery sits—creating a clean installation and resulting in an anti-theft battery mounting solution.

Embodiments of the battery mounting system are made of durable, recyclable materials and can be easily configured to fit any type and size of battery. One embodiment of the battery mounting system is configured for use with a vehicle battery having a shell with four sides that occupy a battery footprint. The battery shell also includes integrated hold-down features. An embodiment of the battery mounting system broadly compromises a mount body and at least one hold-down element.

The mount body includes a substantially planar upper mounting surface; a lower surface opposite the mounting surface; and at least one mounting element for securing the mount body to a vehicle. The battery hold-down element engages with the hold-down features on the battery for securing the battery to the mount body. Both the mounting element on the mount body and the battery hold-down element include anti-theft features that prevent the mount body from being removed from the vehicle and prevent the battery from being removed from the mount body without a unique unlocking device.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the present invention are described in detail below with reference to the attached drawing figures, wherein:

FIG. 1 is a top perspective view of a battery mounting system constructed in accordance with embodiments of the present invention.

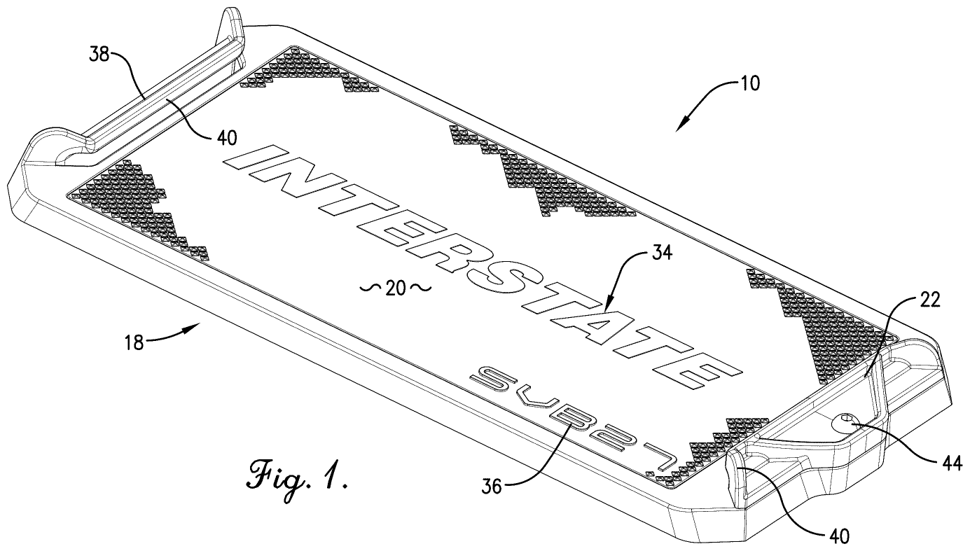

FIG. 2 is an exploded view of the battery mounting system.

FIG. 3 is a bottom perspective view of the battery mounting system.

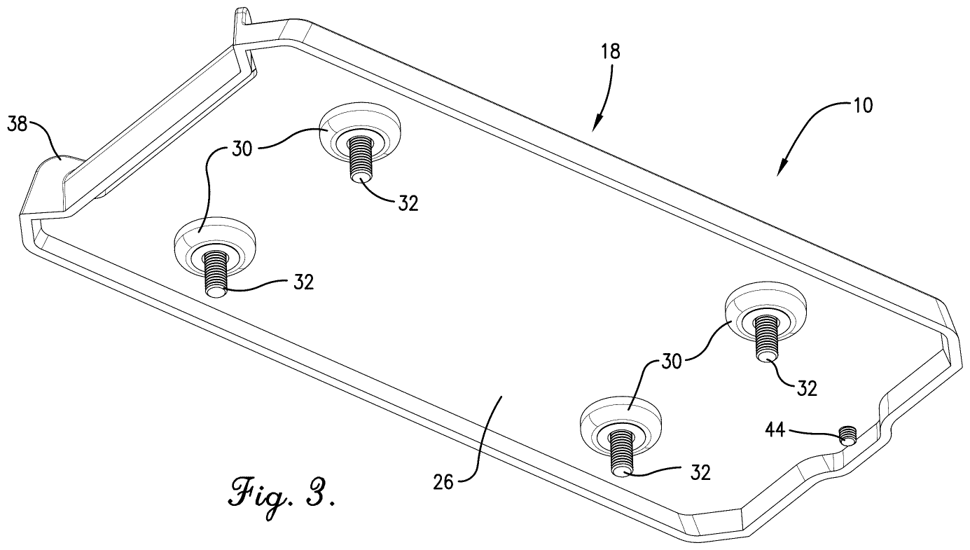

FIG. 4 is a perspective view of the battery mounting system with a battery secured to it.

The drawing figures do not limit the present invention to the specific embodiments disclosed and described herein. The drawings are not necessarily to scale, emphasis instead being placed upon clearly illustrating the principles of the invention.

### DESCRIPTION OF EMBODIMENTS OF INVENTION

A battery mounting system 10 (also referred to herein as “battery mount” or “battery mounts”) constructed in accordance with embodiments of the present invention will now be described with reference to the attached drawing figures. As described in more detail below, the battery mounting system 10 closely interacts with the hold down features of a specified battery to secure the battery nearly anywhere in a vehicle. The battery mount 10 prevents excessive battery movement—reducing impact shock and vibration to the battery. The battery mount allows multiple batteries to be mounted closer to each other without occupying too much space in a vehicle. The battery mount can be secured with a locking feature, thus preventing theft, and specifies the correct battery group to use when replacing the battery. The battery mount may also feature brand identity to encourage brand loyalty whenever the battery needs to be replaced. Embodiments of the battery mount include an anti-slip inlay that conceals mounting hardware—creating a clean installation and resulting in an anti-theft battery mounting solution.

The battery mount 10 may be used with any vehicle batteries, including lithium batteries, absorbent glass mat batteries, flooded lead-acid batteries, A/B type batteries, solid-state batteries, or any other battery types designed for use in vehicles and other devices. The batteries to which the battery cover assemblies of the present invention are attached may be designed to start internal combustion engines or may power the electric motors of electrically powered vehicles.

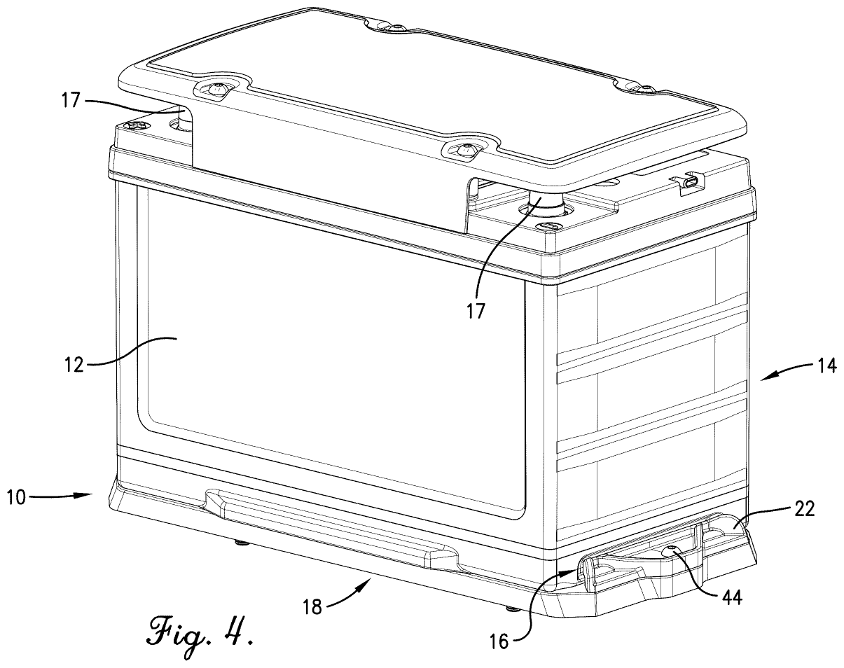

An exemplary battery 12 which may be mounted on the battery mount of the present invention is depicted in FIG. 4 and includes a partially hollow shell 14 that encloses a number of conventional battery plates and/or other components. The shell has four sides that occupy a battery footprint. The battery also has integrated hold-down features 16, and external positive and negative terminals 17 extending through its cover and electrically connected to the internal battery components. The positive and negative terminals are configured to connect with battery cables in a vehicle. The battery shell may be formed of any corrosion-resistant materials and conforms to BCI℠ Battery Group Size requirements and/or other battery group size specifications.

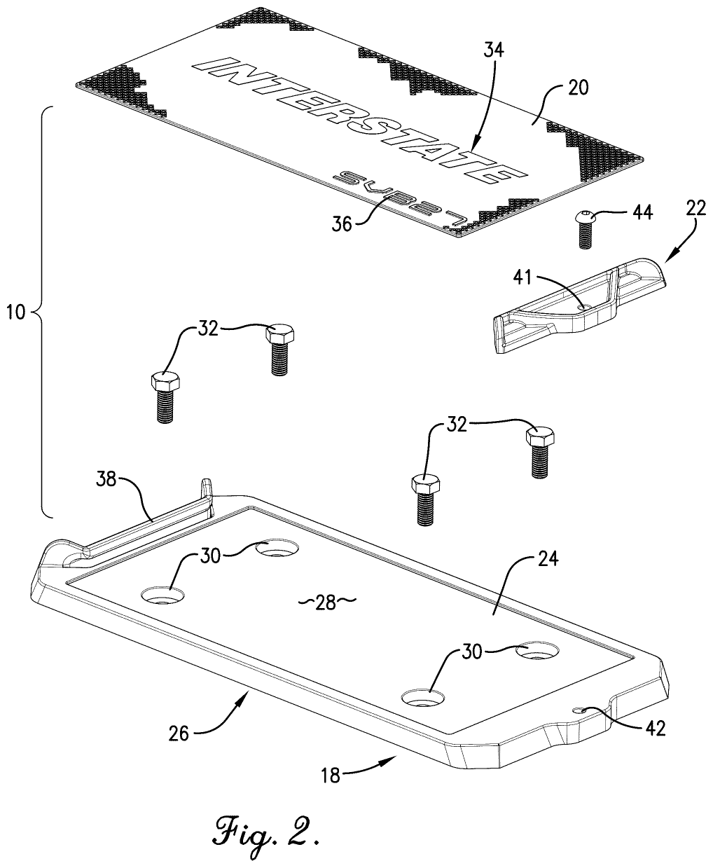

An embodiment of the battery mount 10 will now be described with reference to the attached drawing figures. The components of the battery mount are made of durable, recyclable materials and can be easily configured to fit any type and size of battery. As best shown in FIG. 2, an embodiment of the battery mount 10 broadly comprises a mount body 18; a non-slip inlay 20, and at least one battery hold-down element 22.

The mount body 18 is generally rectangular and includes a substantially planar upper mounting surface 24 and an opposite lower surface 26. As best shown in FIG. 4, the mount body 18 presents a footprint that extends outside the battery footprint on two or less sides of the battery. In one embodiment, the footprint of the mount body extends beyond the battery footprint only on the two shorter sides of the battery. As best shown in FIG. 2, the upper surface of the mount body has a recessed central area 28 for receiving the non-slip inlay 20 as described below.

The mount body 18 also has at least one mounting element 30 for securing the mount body to a vehicle. In one embodiment, the mounting element includes a number of holes that extend through the upper and lower surfaces 24, 26 of the mount body. The holes are countersunk so as to provide flush mounting of the fasteners. Bolts, screws, or other fasteners 32 can be inserted through these holes 30 and threaded into aligned holes drilled in battery mounting locations of a vehicle. In one embodiment, the fasteners 32 have a unique head pattern so they can only be removed with a key that fits the fastener head pattern or other anti-theft unlocking element to prevent the mount body from being removed from the vehicle without the key.

In other embodiments, the mounting element 30 is configured to engage with an anti-theft unlocking element embodied in keys, sockets, wrenches, drivers, pins, numerical combinations, electrical signals, fingerprint recognition devices, facial recognition devices, password devices, push-buttons, or magnets.

The non-slip inlay 20 fits within the recessed area 28 of the upper surface 24 of the mount body and covers the mounting elements 30 and fasteners 32. It may be formed of rubber or other flexible and shock-absorbing materials and has a textured non-slip upper surface so that it absorbs shocks and vibrations and resists movement of the battery while on the mount body. Branding 34 and a battery size indicator 36 may be printed or otherwise formed on the top of the inlay.

The battery hold-down element 22 securely holds the battery 12 on the battery mount 10 and prevents the battery from being removed by an unauthorized person by engaging with the hold-down features 16 on the battery 12. In one embodiment, the battery mount includes one fixed battery hold-down element 38 and one removeable hold-down element 22. Both hold-down elements have tabs 40 that fit within the hold-down features 16 formed in the battery shell. The removeable hold-down element 22 also includes a hole 41 that aligns with a threaded hole 42 in the mount body when the hold-down element 22 is attached to the mount body.

In use, the mounting system 10 is first attached to a space in a vehicle with the mounting elements 30 and corresponding fasteners 32. The fasteners 32 and mounting elements 30 are then covered by the inlay 20. To install the battery 12 on the mounting system 10, the battery is placed on the mount body 18 so that the hold-down feature 16 on one side of the battery is under the fixed hold-down element 38. Then, the removable hold-down element 22 is placed in the other hold-down feature 16 on the battery. The holes 41, 42 are then aligned, and a bolt, screw, or other fastener 44 is placed through the aligned holes to firmly hold the battery on the mount body. In one embodiment, the fastener 44 has a unique head pattern so that it can only be removed with a key that fits the fastener head pattern to prevent the battery from being removed without the key. In other embodiments, the removeable hold-down element can only be removed from the mount body with an anti-theft unlocking element embodied in keys, sockets, wrenches, drivers, pins, numerical combinations, electrical signals, fingerprint recognition devices, facial recognition devices, password devices, push-buttons, or magnets.

### ADDITIONAL CONSIDERATIONS

The detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The detailed description is, therefore, not to be taken in a limiting sense. The scope of the current invention is defined only by the appended claims, along with the full scope of equivalents to which such claims are entitled.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A battery mount system for securing a battery of a battery group size to a vehicle surface, the battery having four sides that occupy a battery footprint and integrated hold-down features, the battery mount system comprising:
a mount body comprising:
four sides that form a footprint, two of the sides of the mount body covered by two of the sides of the battery such the footprint of the mount body extends outside the battery footprint on two or less of the sides of the battery;
a substantially planar upper mounting surface;
a lower surface opposite the upper mounting surface;
at least one mounting element; and
at least one battery hold-down element for engaging with the hold-down features on the battery and securing the battery to the mount body.

2. The battery mount system of claim 1, wherein the at least one mounting element is a through-hole.

3. The battery mount system of claim 1, wherein the at least one battery hold-down element further comprises an anti-theft locking element.

4. The battery mount system of claim 3, wherein the anti-theft locking element utilizes a mating anti-theft unlocking element.

5. The battery mount system of claim 4, wherein the mating anti-theft unlocking element is selected from the group consisting of keys, sockets, wrenches, drivers, pins, numerical combinations, electrical signals, fingerprint recognition, facial recognition, password, push-buttons, and magnets.

6. The battery mount system of claim 1, wherein the at least one mounting element further comprises an anti-theft locking element.

7. The battery mount system of claim 6, further compromising a mating anti-theft unlocking element that can engage the anti-theft locking element.

8. The battery mount system of claim 7, wherein the mating anti-theft unlocking element is selected from the groups consisting of keys, sockets, wrenches, drivers, pins, numerical combinations, electrical signals, fingerprint recognition, facial recognition, password, push-buttons, and magnets.

9. The battery mount system of claim 1, further comprising a mount body inlay.

10. The battery mount system of claim 9, wherein the mount body inlay covers the at least one mounting element when the mount body is mounted to the vehicle surface.

11. The battery mount system of claim 9, wherein the mount body inlay is made of materials that exhibit anti-slip properties.

12. The battery mount system of claim 1, wherein the mount body is formed via a manufacturing process selected from the group of molding, casting, stamping, additive manufacturing, and subtractive manufacturing.

13. The battery mount system of claim 1, wherein the mount body further comprises a threaded element for receiving the at least one battery hold-down element.

14. The battery mount system of claim 1, wherein the mount body further comprises a battery group size identifier.

15. A battery mount system for securing a battery of a specific battery group size to a surface, the battery having four sides that occupy a battery footprint and integrated hold-down features, the battery mount system comprising:
a mount body comprising four sides that form a footprint, two of the sides aligned with and covered by two of the sides of the battery such the footprint of the mount body extends outside the battery footprint on two or less of the sides of the battery, the mount body further comprising:
a substantially planar mounting surface;
a surface opposite the substantially planar mounting surface;
at least one mounting element;
at least one integrated battery hold-down element for engaging with the hold-down features on the battery and securing the battery to the mount body; and
at least one removable battery hold-down element for engaging with the hold-down features on the battery and securing the battery to the mount body.

16. The battery mount system of claim 15, wherein the at least one mounting element is a through-hole.

17. The battery mount system of claim 15, wherein the at least one removable battery hold-down element further comprises an anti-theft locking element.

18. The battery mount system of claim 17, further compromising a mating anti-theft unlocking element that can engage the anti-theft locking element.

19. The battery mount system of claim 18, wherein the mating anti-theft unlocking element is selected from the group consisting of keys, sockets, wrenches, drivers, pins, numerical combinations, electrical signals, fingerprint recognition, facial recognition, password, push-buttons, and magnets.

20. The battery mount system of claim 15, wherein the at least one mounting element further comprises an anti-theft locking element.

21. The battery mount system of claim 20, further compromising a mating anti-theft unlocking element that can engage the anti-theft locking element.

22. The battery mount system of claim 21, wherein the mating anti-theft unlocking element is selected from the group consisting of keys, sockets, wrenches, drivers, pins, numerical combinations, electrical signals, fingerprint recognition, facial recognition, password, push-buttons, and magnets.

23. The battery mount system of claim 15, further comprising a mount body inlay.

24. The battery mount system of claim 23, wherein the mount body inlay covers the at least one mounting element when the mount body is mounted to a surface.

25. The battery mount system of claim 23, wherein the mount body inlay is made of materials that exhibit anti-slip properties.

26. The battery mount system of claim 15, wherein the mount body is formed via a manufacturing process selected from the group of molding, casting, stamping, additive manufacturing, and subtractive manufacturing.

27. The battery mount system of claim 15, wherein the mount body further comprises a threaded element for receiving the at least one battery hold-down element.

28. The battery mount system of claim 15, wherein the mount body further comprises a battery group size identifier.

29. A battery mount system for securing a battery of a specific battery group size to a surface, the battery having four sides that occupy a battery footprint, the battery mount system comprising:
a mount body comprising:
four sides that form a footprint, two of the sides of the mount body covered by two of the sides of the battery such the footprint of the mount body extends outside the battery footprint on two or less of the sides of the battery;
a substantially planar mounting surface;
a surface opposite the substantially planar mounting surface;
at least one mounting element;
a mount body inlay that covers the at least one mounting element when the mount body is mounted to the surface; and
at least one battery hold-down element for securing the battery to the mount body.

30. The battery mount system of claim 29, wherein the at least one mounting element further comprises an anti-theft locking element.

31. The battery mount system of claim 30, further compromising a mating anti-theft unlocking element that can engage the anti-theft locking element.

32. The battery mount system of claim 31, wherein the mating anti-theft unlocking element is selected from the group consisting of keys, sockets, wrenches, drivers, pins, numerical combinations, electrical signals, fingerprint recognition, facial recognition, password, push-buttons, and magnets.

33. A battery mount system for securing a battery of a specific battery group size to a surface, the battery having four sides that occupy a battery footprint, the battery mount system comprising:
a mount body comprising:
four sides that form a footprint, two of the sides covered by two of the sides of the battery such the footprint of the mount body extends outside the battery footprint on two or less of the sides of the battery;
a substantially planar mounting surface;
a surface opposite the substantially planar mounting surface;
at least one anti-theft locking mounting element located under the footprint of the battery; and
at least one anti-theft locking battery hold-down element for securing the battery to the mount body.
